(19) United States
(12) Patent Application Publication
(10) Pub. No.: US 2015/0073829 A1
(43) Pub. Date: Mar. 12, 2015

(54) METHOD AND SYSTEM FOR DISTRIBUTING PATIENT DATA AND PATIENT STATUS NOTIFICATIONS

(71) Applicant: Geisinger Clinic, Danville, PA (US)

(72) Inventors: Eric D. Newman, Danville, PA (US); James B. Jones, Lewisburg, PA (US); Virginia R. Lerch, Danville, PA (US); Jonathan Billet, Lewisburg, PA (US)

(73) Assignee: Geisinger Clinic, Danville, PA (US)

(21) Appl. No.: 14/448,211

(22) Filed: Jul. 31, 2014

Related U.S. Application Data
(63) Continuation of application No. 14/024,958, filed on Sep. 12, 2013, now abandoned.

(51) Int. Cl. G06F 19/00

(52) U.S. Cl. CPC G06F 19/34
USPC 705/3

(57) ABSTRACT

A method for distributing patient data includes: storing patient data entries, each entry including a patient identifier and patient data points, each point being associated with an access control; storing a plurality of user data entries, each user entry including a user identifier, authentication information, and access control information; receiving questionnaire answers and a specific patient identifier associated with the patient; updating the points in a specific patient entry including the specific patient identifier based on the questionnaire answers; receiving a patient data request including the specific patient identifier, a specific user identifier, and supplied authentication information; and transmitting a subset of points based on the access control associated with each point in the subset and the access control information included in a specific user data entry including the specific user identifier, if the supplied authentication information matches the authentication information included in the specific user data entry.

### FIELD

The present disclosure relates to the distribution of patient data and patient status to health care professionals, specifically the use of an integrated system for the synchronous storage and distribution of patient data to health care providers based on user access controls.

### BACKGROUND

In past times, the health care industry traditionally operated through the use of physical files to hold a patient's medical records, which would follow the patient from facility to facility. With the advent of computer technology, physical medical records have given way to electronic health records (EHRs) and electronic medical records (EMRs), which are electronic versions of traditional patient medical records. Such electronically-stored records can provide for more efficient storage of patient data, as well as ease the process of transferring data from one facility to another.

Systems and methods have been designed to utilize EHRs and EMRs in order to assist health care providers in the provision of services to patients. However, many of these systems are merely electronic versions of traditional physical files, and thereby suffer from many of the same problems, including lack of synchronization across multiple copies, difficulty in finding specific information, lack of information regarding treatment and long-term trends, and a lack of resources for handling information regarding chronic illnesses. As such, these systems and methods improve the storage and transfer of EMRs and EHRs, but do little to take advantage of technology to improve patient care itself.

Thus, there is a need for a technical solution to provide for improved patient care in terms of the collection, collation, and distribution of patient data and patient status notifications.

### SUMMARY

The present disclosure provides a description of systems and methods for the collection, collation, and distribution of patient data and the notification to a health service professional of patient status.

A method for distributing patient data, includes: storing, in a patient database, a plurality of patient data entries, wherein each patient data entry includes data related to a patient including at least a patient identifier and a plurality of patient data points, each patient data point in the plurality of patient data points being associated with an access control; storing, in a user database, a plurality of user data entries, wherein each user data entry includes data related to a user including at least a user identifier, authentication information, and access control information; receiving, by a receiving device, at least questionnaire answers related to at least medical symptoms or history associated with a patient and a specific patient identifier associated with the patient; updating, in the patient database, the plurality of patient data points included in a specific patient data entry, where the included patient identifier corresponds to the specific patient identifier, based on the received questionnaire answers; receiving, by the receiving device, a request for patient data, wherein the request for patient data includes the specific patient identifier, a specific user identifier, and supplied authentication information; and transmitting, by a transmitting device, a subset of the plurality of patient data points included in the specific patient data entry based on the access control associated with each patient data point in the subset of the patient data points and the access control information included in a specific user data entry, where the user identifier included in the specific user data entry corresponds to the specific user identifier, if the supplied authentication information corresponds to the authentication information included in the specific user data entry.

Another method for distributing patient data, includes: storing, in a patient database, a plurality of patient data entries, wherein each patient data entry includes data related to a patient including at least a patient identifier and a plurality of patient data points, each patient data point in the plurality of patient data points including medical data associated with the related patient; receiving, by a receiving device, widget registration information, wherein the widget registration information includes at least an identification of a subset of patient data points; identifying, by a processing device, a widget identifier to be associated with the received widget registration information; storing, in a widget database, a widget data entry corresponding to the widget registration information, wherein the widget data entry includes at least the widget identifier and the identification of the subset of patient data points; receiving, by the receiving device, a data request, wherein the data request includes at least the widget identifier and a specific patient identifier; identifying, in the patient database, a specific patient data entry where the included patient identifier corresponds to the specific patient identifier; and transmitting, in response to the data request, data included in each of the plurality of patient data points included in the specific patient data entry corresponding to the subset of data points identified in the widget data entry.

A method for notifying a health service professional of patient status, includes: storing, in a patient database, a plurality of patient data entries, wherein each patient data entry includes data related to a patient including at least a patient identifier, a plurality of patient data points, and a patient status indicator; receiving, from a first computing device, at least questionnaire answers related to at least medical symptoms or history supplied by a patient and a specific patient identifier associated with the patient; identifying, in the patient database, a specific patient data entry where the included patient identifier corresponds to the specific patient identifier; updating, in the patient database, the plurality of patient data points included in the specific patient data entry based on the received questionnaire answers and the patient status indicator included in the specific patient data entry to indicate completion of a questionnaire; and transmitting, by a transmitting device, notification of completion of the questionnaire to a second computing device, wherein the notification includes an indication that the receiving device has received the questionnaire answers supplied by the patient related to the specific patient data entry.

A system for distributing patient data includes a transmitting device, a patient database, a user database, a receiving device, and a processing device. The patient database is configured to store a plurality of patient data entries, wherein each patient data entry includes data related to a patient including at least a patient identifier and a plurality of patient data points, each patient data point in the plurality of patient data points being associated with an access control. The user database is configured to store a plurality of user data entries, wherein each user data entry includes data related to a user including at least a user identifier, authentication information, and access control information. The receiving device is configured to receive at least questionnaire answers related to at least medical symptoms or history supplied by a patient and a specific patient identifier associated with the patient. The processing device is configured to update, in the patient database, the plurality of patient data points included in a specific patient data entry, where the included patient identifier corresponds to the specific patient identifier, based on the received questionnaire answers. The receiving device is further configured to receive a request for patient data, wherein the request for patient data includes the specific patient identifier, a specific user identifier, and supplied authentication information. The transmitting device is configured to transmit a subset of the plurality of patient data points included in the specific patient data entry based on the access control associated with each patient data point in the subset of the patient data points and the access control information included in a specific user data entry, where the user identifier included in the specific user data entry corresponds to the specific user identifier, if the supplied authentication information corresponds to the authentication information included in the specific user data entry.

Another system for distributing patient data includes a transmitting device, a widget database, a patient database, a receiving device, and a processing device. The patient database is configured to store a plurality of patient data entries, wherein each patient data entry includes data related to a patient including at least a patient identifier and a plurality of patient data points, each patient data point in the plurality of patient data points including medical data associated with the related patient. The receiving device is configured to receive widget registration information, wherein the widget registration information includes at least an identification of a subset of patient data points. The processing device is configured to: identify a widget identifier to be associated with the received widget registration information; and store, in the widget database, a widget data entry corresponding to the widget registration information, wherein the widget data entry includes at least the widget identifier and the identification of the subset of patient data points. The receiving device is further configured to receive a data request, wherein the data request includes at least the widget identifier and a specific patient identifier. The processing device is further configured to identify, in the patient database, a specific patient data entry where the included patient identifier corresponds to the specific patient identifier. The transmitting device is configured to transmit, in response to the data request, data included in each of the plurality of patient data points included in the specific patient data entry corresponding to the subset of data points identified in the widget data entry.

A system for notifying a health service professional of patient status includes a patient database, a receiving device, a processing device, and a transmitting device. The patient database is configured to store a plurality of patient data entries, wherein each patient data entry includes data related to a patient including at least a patient identifier, a plurality of patient data points, and a patient status indicator. The receiving device is configured to receive, from a first computing device, at least questionnaire answers related to at least medical symptoms or history supplied by a patient and a specific patient identifier associated with the patient. The processing device is configured to: identify, in the patient database, a specific patient data entry where the included patient identifier corresponds to the specific patient identifier; and update, in the patient database, the plurality of patient data points included in the specific patient data entry based on the received questionnaire answers and the patient status indicator included in the specific patient data entry to indicate completion of a questionnaire. The transmitting device is configured to transmit a notification of completion of the questionnaire to a second computing device, wherein the notification includes an indication that the receiving device has received the questionnaire answers supplied by the patient related to the specific patient data entry.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for distributing patient data and patient status notifications in accordance with exemplary embodiments.

FIG. 2 is a block diagram illustrating the processing server and the computing device of FIG. 1 for the transfer and synchronization of patient data in accordance with exemplary embodiments.

FIG. 3 is a flow diagram illustrating a method for the processing of patient status in accordance with exemplary embodiments.

FIG. 4 is a flow diagram illustrating a method for the distribution of patient data based on user access controls in accordance with exemplary embodiments.

FIGS. 5A and 5B are a flow diagram illustrating a method for the creation of a widget and use thereof to distribute patient data in accordance with exemplary embodiments.

FIGS. 6A-6E are diagrams illustrating a graphical user interface for the updating of a patient status, distribution of a notification thereof, and distribution of patient data in accordance with exemplary embodiments.

FIGS. 7A and 7B are diagrams illustrating a graphical user interface for the creation and use of a widget used to distribute patient data in accordance with exemplary embodiments.

FIGS. 8 and 9 are flow charts illustrating exemplary methods for distributing patient data in accordance with exemplary embodiments.

FIG. 10 is a flow chart illustrating an exemplary method for notifying a health service professional of patient status in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Distributing Patient Data and Patient Status Notifications

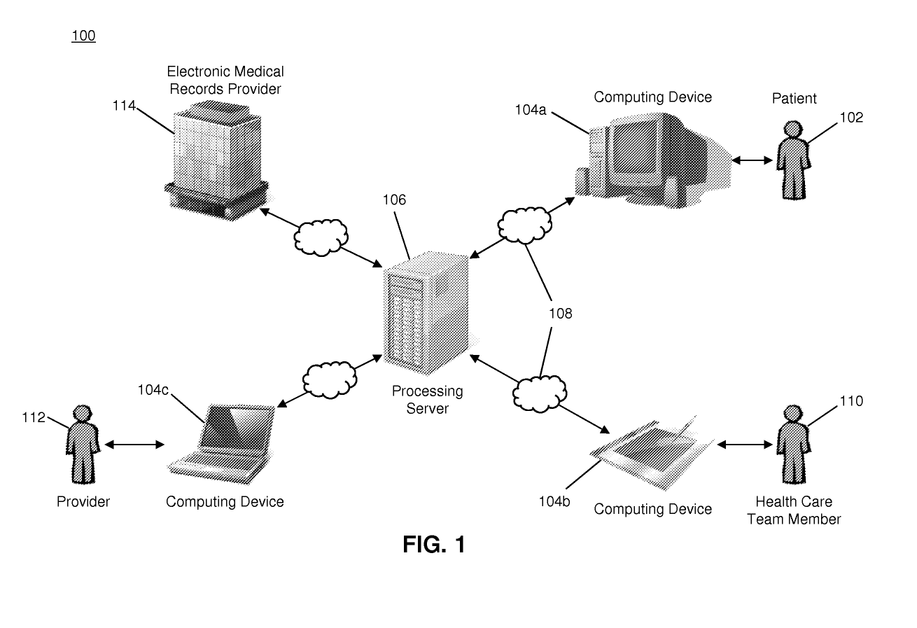

FIG. 1 illustrates a system 100 for the synchronization and distribution of patient data and the distribution of patient status notifications to health service professionals.

As part of the system 100, a patient 102 may use a computing device 104a, discussed in more detail below, to fill out a patient questionnaire in order to gather patient data. The patient questionnaire may include questions, prompts, or any other suitable method to gather data related to at least medical symptoms or medical history supplied by the patient 102. Information included in the patient questionnaire will be apparent to persons having skill in the relevant art. In some embodiments, the questionnaire may be such that the patient 102 selects from pre-established answers to the questions presented in the questionnaire, to avoid or reduce the need for a patient 102 to key in the data, or have a health care team member 110, such as a nurse, nurse's aide, medical technician medical assistant, other health care support staff member, provider 112 (e.g., physician, physician's assistant, nurse practitioner, etc.), or any other suitable person working in a medical facility having authorization for a particular task, etc., key in the data for accuracy and completeness, and data integrity. Entry of data into particular keyed-in data fields might be limited to particular users or user categories by data rights, as a control on data integrity.

The information entered into the computing device 104a may be transmitted to a processing server 106, via a network 108 such as the Internet or a local area network. The processing server 106, discussed in more detail below, may be configured to receive the questionnaire answers from the computing device 104a, and may store the received answers in a patient database, also discussed in more detail below. The patient database may include a patient data entry corresponding to the patient 102, and may be used to store the questionnaire answers provided by the patient 102 and any other relevant or otherwise useful information that will be apparent to persons having skill in the relevant art.

The processing server 106 may then distribute the patient answers and/or other patient data to other computing devices, such as the computing device 104b operated by a health care team member 110. In an exemplary embodiment, the patient data distributed by the processing server 106 may be based on one or more user access controls (e.g., permissions) or categories. For instance, as discussed in more detail below, a first set of patient data may be transmitted to the computing device 104b for display to the health care team member 110, while a different second set of patient data may be transmitted to the computing device 104c for display to the provider 112, for instance.

The processing server 106 may also distribute information, via the network 108, to a medical records provider 114. The medical records provider 114 may be an insurer, medical facility, the patient's own electronic records, third party provider or trusted custodian, or any other entity that may require, acquire or hold patient data for the patient 102. While it is more convenient if the records are in a recognized electronic form, scanning, OCR, data entry, medical transcription, code conversion and other facilities to assist in the importation of the medical records is contemplated. Patient data transmitted by the processing server 106 to the medical records provider 114 or to any computing device 104 may include the patient answers, medical treatment information, medical symptoms, medical history, family medical history, patient care history, patient preferences, allergy information, patient progress, health care professional observations, test and lab results, observations, and health care outcomes for example. In some instances, the patient data may be a part of, or may be provided to be incorporated into, an EMR associated with the patient 102.

In one embodiment, the processing server 106 may also be configured to enable a user, such as the provider 112 or an employee of the medical records provider 114, to develop a widget (e.g., self-contained code that displays a program, or a piece of a program, that is also (usually) a shortcut to a larger application) to be used for accessing and distributing patient data. As discussed in more detail below, a user may utilize the widget to select a plurality of patient data points of the patient data. When the widget is accessed, the widget may access the patient data points of the patient data and may distribute the corresponding information for display on the computing device 104 where the widget was accessed. In some instances, the widget may have multiple configurations such that the plurality of data points distributed to the computing device 104 may be dependent on user access controls or a user category of the user accessing the widget.

In another embodiment, the processing server 106 may also be configured to distribute patient status notifications. In such an embodiment, once the patient 102 has finished submitting answers to the patient questionnaire on the computing device 104a, the processing server 106 may update a patient data entry corresponding to the patient 102 in a patient database, and then transmit a notification to the computing device 104b to notify the health care team member 110 that the patient has completed the questionnaire. Similarly, the processing server 106 may also be configured to receive an indication from the health care team member 110 that the patient 102 is ready to be seen by the provider 112, for instance, and may then transmit a notification to the computing device 104c to notify the provider 112 that the patient 102 is ready to be seen.

The distribution of patient status notifications to the health care team member 110 may improve the speed and efficiency at which health care may be provided to the patient 102. Such a system may enable the health care team member 110 and provider 112, or other health care provider, to freely perform other duties while the patient 102 is busy, but be readily available when the patient 102 has completed their questionnaire. The distribution of patient data to the computing devices 104b and 104c from the processing server 106 may also improve the speed at which the health care team member 110 and the provider 112 may be able to provide treatment, which may result in a more efficient, and therefore considerably more effective, system of providing health care.

Notifications may also be utilized by the processing server 106 (e.g., as distributed to respective computing devices 104) to provide more efficient care by notifying the correct entity (e.g., the health care team member 110 or provider 112) of tasks to be performed and the relevant information at the most opportune times.

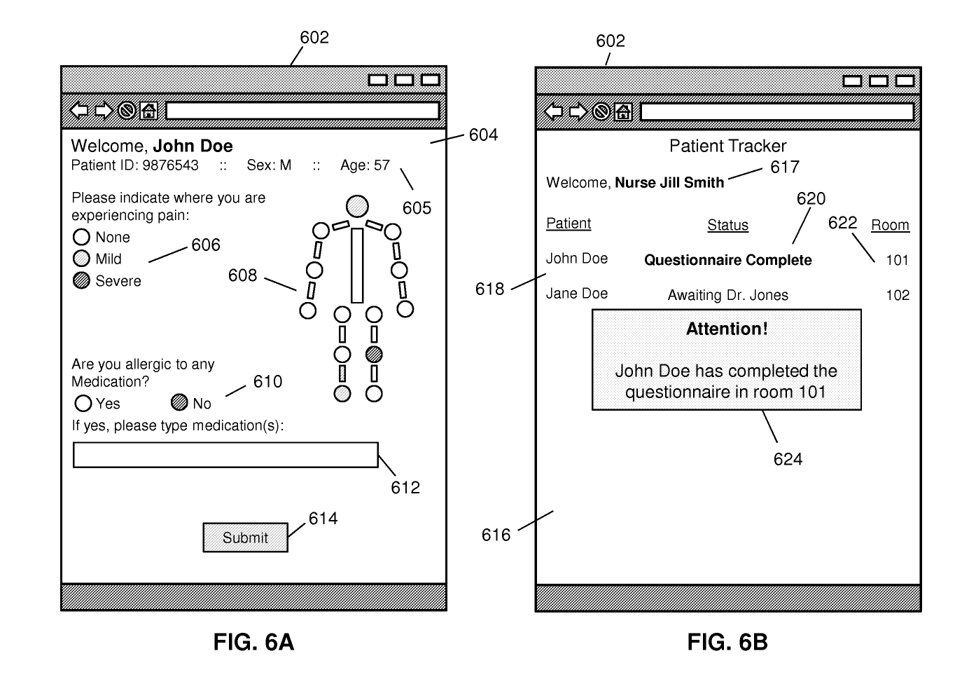

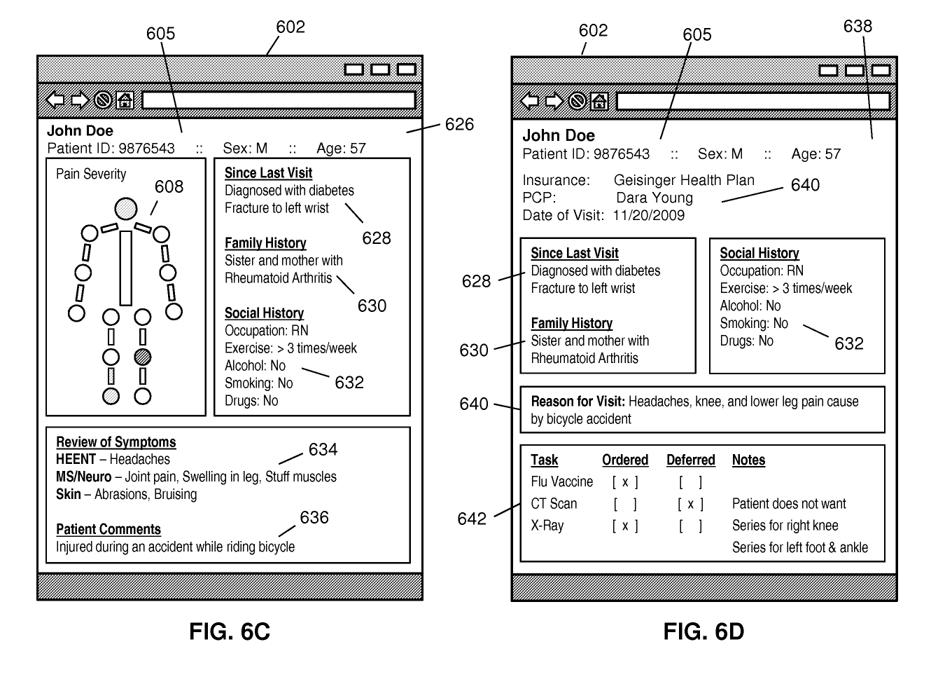

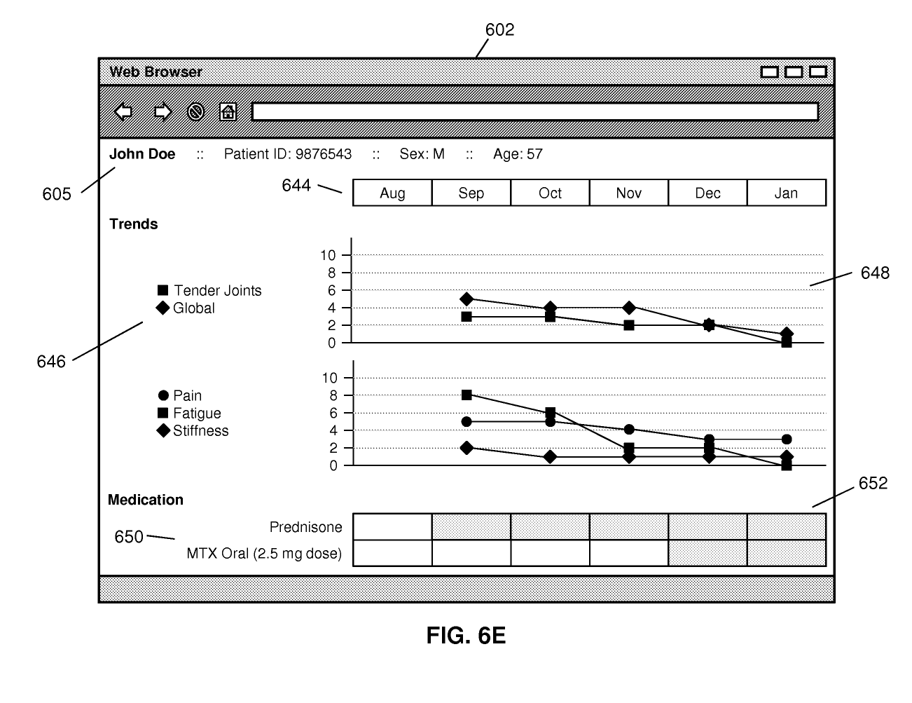

The processing server 106 may also aggregate the data received from one or more, even multiple sources (e.g., the patient questionnaire, additional information input by the health care team member 110, diagnoses and treatment instructions from the provider 112, additional records provided by a medical records provider 114, etc.) to establish trends and other contextual representations that may result in more efficient and effective patient care, such as illustrated in FIG. 6E and discussed in more detail below.

### Processing Server

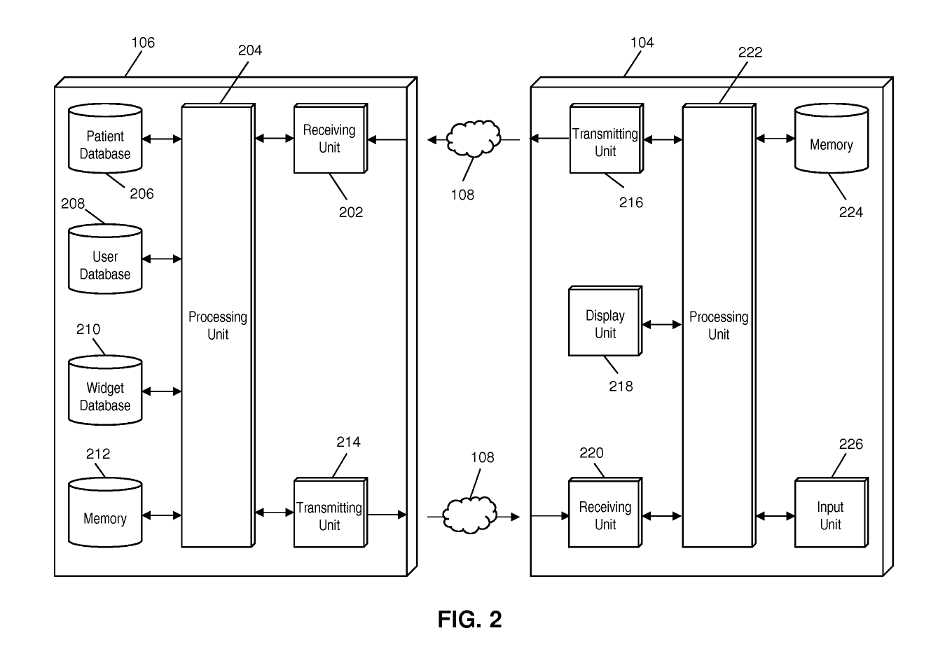

FIG. 2 illustrates embodiments of the processing server 106 and one of the computing devices 104. It will be apparent to persons having skill in the relevant art that the embodiment of each of the processing server 106 and the computing device 104 is provided as illustration only and may not be exhaustive as to all possible configurations of the processing server 106 and the computing device 104. Each of the processing server 106 and the computing device 104 may include additional components, units, devices, databases, etc. as will be apparent to persons having skill in the relevant art.

The processing server 106 may be a computing device configured to perform the functions discussed herein, such as general purpose computer or a special purpose computer. The processing server 106 may include a receiving unit 202. The receiving unit 202 may be configured to communicate with the network 108 or any other suitable network via one or more network protocols to receive patient data (e.g., from the computing device 104, an EMR, etc.) or updates on patient status.

The processing server 106 may also include a processing unit 204, such as a processor (e.g., a central processing unit), configured to perform the functions discussed herein. The processing unit 204 may consist of a single processor, multiple processors interfaced together, or any other suitable configuration. Each processor that may comprise the processing unit 204 may include one or more processing cores as will be apparent to persons having skill in the relevant art.

The processing server 106 may also include a patient database 206. The patient database 206 may store a plurality of patient data entries, each patient data entry including data related to a patient (e.g., the patient 102). The patient data entry may include a patient identifier and a plurality of patient data points. The patient identifier may be a unique value associated with the related patient for use in identifying the related patient and/or the patient data entry. For example, the patient identifier may be a name, address, phone number, e-mail address, username, social security number, tax identification number, license number, insurance policy number, any combination thereof, or any other suitable value or combination of values as will be apparent to persons having skill in the relevant art.

The patient data may include, as discussed above, at least one of: patient answers, medical treatment information, medical symptoms, medical history, patient care history, patient preferences, allergy information, patient progress, health care professional observations, and health care outcomes. The patient data may be a part of, or may include data obtained from, an EMR associated with the related patient.

The processing server 106 may also include a user database 208. The user database 208 may include a plurality of user data entries, each user data entry including data related to a user (e.g., the patient 102, the health care team member 110, the provider 112, etc.) including at least a user identifier, authentication information, and access control information. The user identifier may be any unique value suitable for identification of the related user, such as a username. The authentication information may be information used by the processing unit 204 to authenticate the user of the processing server 106, such as a password, biometrics, etc. Other suitable information and/or values used as the user identifier and authentication information will be apparent to persons having skill in the relevant art.

The access control information may be information used by the processing unit 204 to determine what patient data points may be accessed (e.g., distributed) by the related user when accessing patient data for a specific patient 102. The access control information may specify particular data, may correspond to a position, a user permission group, or a combination thereof. The processing unit 204 may be configured to identify the access control information for a user accessing a patient data entry and may (e.g., based on access control settings configured for a specific widget, application program, etc.) select specific patient data points for distribution to the computing device 104 being accessed by the user. An example of variance in distribution of patient data to a user based on access control information is provided in more detail below with respect to FIGS. 6C and 6D.

The processing server 106 may also include a widget database 210. The widget database may be configured store a plurality of widget data entries each including data related to a widget. The widget data entries may include at least a widget identifier and an identification of a subset of patient data points. The widget identifier may be a unique value suitable for identification of the widget, such as an identification number. The identification subset of patient data points may identify one or more patient data points included in the patient data for distribution to a computing device 104 when the corresponding widget is accessed. In some embodiments, each widget data entry may also include one of: a widget name, widget description, graphical layout, access control information, scripts, etc.

The processing server 106 may also include a memory 212. The memory 212 may be any suitable type of memory, such as read-only memory, random access memory, flash memory, cloud-based memory, or any combination thereof, for storing additional data. For example, the memory 212 may store program code corresponding to widgets stored in the widget database 210 (e.g., identified using the widget identifier) that may be executed by the processing unit 204, program code corresponding to a widget design application program, an operating system, and any other data that will be apparent to persons having skill in the relevant art.

The processing server 106 may also include a transmitting unit 214. The transmitting unit 214 may be configured to transmit data via the network 108 or one or more other networks via one or more network protocols. The transmitting unit 214 may transmit patient data corresponding to one or more identified patient data points to the computing device 104, health care provider 114, or other entity. The transmitting unit 214 may also transmit patient data to be included as part of an EMR for the corresponding patient.

### Computing Device

As illustrated in FIG. 2, the computing device 104 may include a transmitting unit 216. Similar to the transmitting unit 214 of the processing server 106, the transmitting unit 216 may be configured to transmit data via the network 108 or one or more other networks via one or more network protocols. The transmitting unit 216 may transmit patient data (e.g., patient answers), patient status information, or any other information transmitted as part of the systems and methods disclosed herein to the computing device 106 via the network 108.

The computing device 104 may also include a display unit 218. The display unit 218 may be configured to display data or other information to a user, such as the patient 102, the health care team member 110, or the provider 112. The display unit 218 may be any type of display suitable for performing the functions as disclosed herein, such as a liquid crystal display, light-emitting diode display, plasma display, capacitive touch display, light projection display, etc.

The computing device 104 may also include a receiving unit 220. The receiving unit 220 may be configured to receive data via the network 108 or one or more other networks via one or more network protocols. The receiving unit 220 may receive a patient questionnaire, patient data points, widget information, or any other data that will be apparent to persons having skill in the relevant art.

The computing device 104 may further include a processing unit 222. The processing unit 222 may be configured to perform a variety of functions as discussed herein. For example, the processing unit 222 may be configured to cause the display unit 218 to display a patient questionnaire following the receipt of patient questions by the receiving unit 220. The computing device 104 may also include an input unit 226 configured to receive input from a user. The processing unit 222 may be configured to process the input received via the input unit 226, such as by causing the transmitting unit 216 to transmit the received input to the processing server 106. The input unit 226 may be any type of input suitable for performing the functions disclosed herein, such as a keyboard, mouse, click wheel, touch screen display, microphone, camera, or combination thereof.

The computing device 104 may also include a memory 224. The memory 224 may be any suitable type of memory, such as read-only memory, random access memory, flash memory, cloud-based memory, or any combination thereof, for storing data. The memory 224 may include, for example, program code for one or more application programs, such as a program to display a patient questionnaire, generate a user interface, receive patient answers, display patient data points to a user, etc.

### Processing of Patient Status Notifications

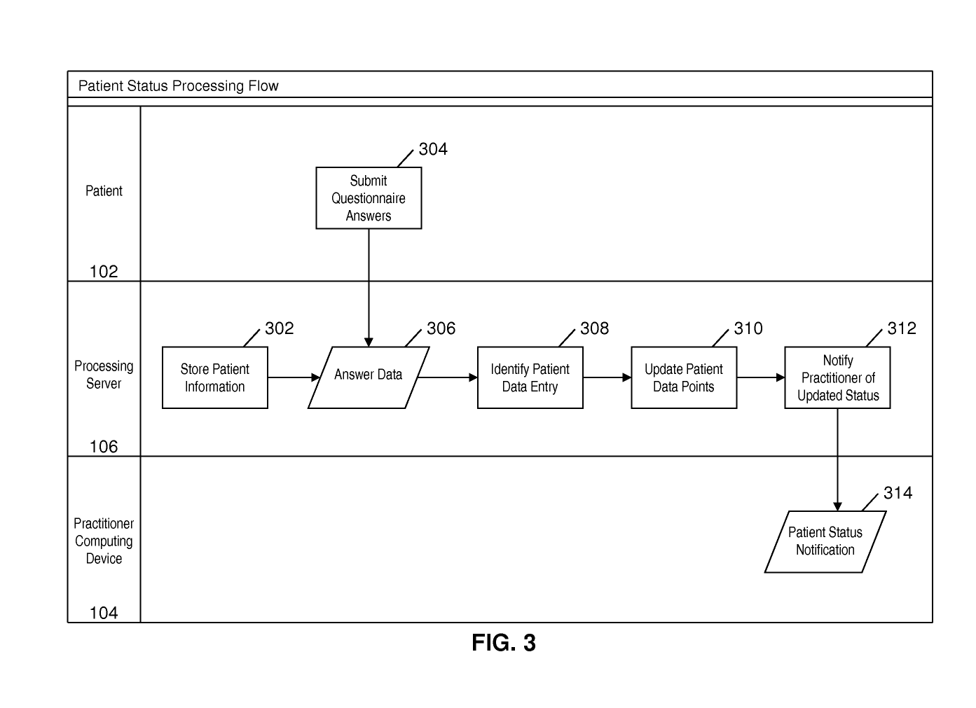

FIG. 3 illustrates a method for the processing of patient status notifications.

In step 302, the processing server 106 may store (e.g., in the patient database 206) information related to the patient 102. The patient information stored in the patient database 206 may be previous medical history or information (e.g., obtained from or part of an EMR), triage information, basic personal information, or any other information that will be apparent to persons having skill in the relevant art. In step 304, the patient 102 may submit (e.g., via the input unit 226 of the computing device 104a) answers to a patient questionnaire. In one embodiment, the patient questionnaire may include questions designed to obtain the patient's medical history and/or current medical symptoms. In another embodiment, the patient questionnaire may include predefined answers (e.g., via drop-down menus, decision trees, etc.) for selection by the patient 102.

In step 306, the processing server 106 may receive (e.g., via the receiving unit 202) the answer data transmitted by the computing device 104a. The answer data may include the answers submitted by the patient 102 as well as a patient identifier associated with the patient 102. The processing server 106 then may, in step 308, identify a patient data entry in the patient database 206 based on the patient identifier included in the answer data. Once the patient data entry has been identified, then the processing unit 204 of the processing server 106 may update the patient data included in the patient data entry based on the questionnaire answers included in the answer data, in step 310.

In step 312, the processing server 106 may then transmit (e.g., via the transmitting unit 214) a notification to a practitioner computing device 104 (e.g., the computing device 104b and/or computing device 104c) to notify a health care professional that the patient 102 has completed their questionnaire. In step 314, the practitioner computing device 104 may receive the patient status notification, which may then be displayed (e.g., by the display unit 218) to the user to update the user on the patient's status. In some embodiments, the patient status notification may also include a plurality of patient data points included in the patient data entry, which may also be displayed to the user of the practitioner computing device 104. In a further embodiment, the patient data points included in the patient status notification may be based on access control information included in a user data entry corresponding to the user.

### Distribution of Patient Data

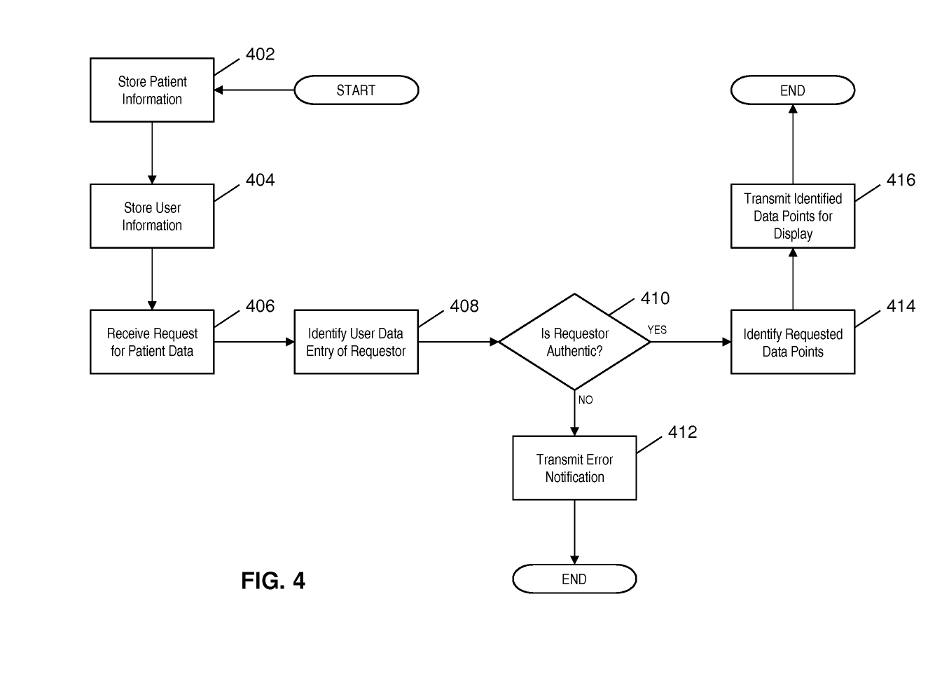

FIG. 4 illustrates a method 400 for the distribution of patient data from the processing server 106 to a computing device 104.

In step 402, the processing server 106 may store, in the patient database 206, patient information related to a patient 102. The patient information may include a patient identifier and patient data, which may be comprised of one or more patient data points including medical symptom and medical history information. In step 404, the processing server 106 may also store, in the user database 208, user information related to one or more users, such as the health care team member 110 and the provider 112. The user information may include at least a user identifier, authentication information, and access control information.

In step 406, the processing server 106 may receive (e.g., via the receiving unit 202), a request for patient data from a computing device 104. The request for patient data may include a patient identifier corresponding to the patient 102, a user identifier corresponding to the user that submitted the request for patient data, and authentication information. In step 408, the processing server 106 may identify, in the user database 208, a user data entry corresponding to the user that submitted the request based on the included user identifier.

In step 410, the processing unit 204 may determine if the user that submitted the request for patient data is authentic, based on the authentication information submitted in the patient data request as well as the authentication information included in the identified user data entry. If the authentication information does not correspond (e.g., the user submitted incorrect authentication information), then, in step 412, the processing server 106 may transmit (e.g., via the transmitting unit 214) an error notification to the computing device 104 to notify the user of the failed authentication. Methods for authenticating a user of a computing device will be apparent to persons having skill in the relevant art.

If, in step 410, the user was successfully authenticated, then the processing server 106 may identify, in a patient data entry corresponding to the patient 102 in the patient database 206, data points requested by the user. In some instances, the request for patient data may include specific patient data points. In other instances, the patient data points identified in step 414 by the processing unit 204 of the processing server 106 may be based on access control information included in the identified user data entry. For example, if the user is indicated as being a health care team member 110 by the access control information, then the processing unit 204 may identify only those specific patient data points in the patient data entry that are relevant to the health care team member 110. Methods for identifying specific data based on user access controls will be apparent to persons having skill in the relevant art.

In step 416, the transmitting unit 214 of the processing server 106 may transmit the identified data points to the computing device 104 for display (e.g., via the display unit 218) to the user. In some embodiments, the patient data request may be automatically submitted to the processing server 106 upon completion of the patient questionnaire by the patient 102. In such an embodiment, the processing server 106 may then provide patient data points based on the questionnaire answers to the computing device 104b along with a notification indicating to the health care team member 110 that the patient 102 has completed the questionnaire. The health care team member 110 may thus be able to quickly return to the patient 102 to continue providing helpful care with relevant information already readily available via the computing device 104b.

### Widget Creation and Processing

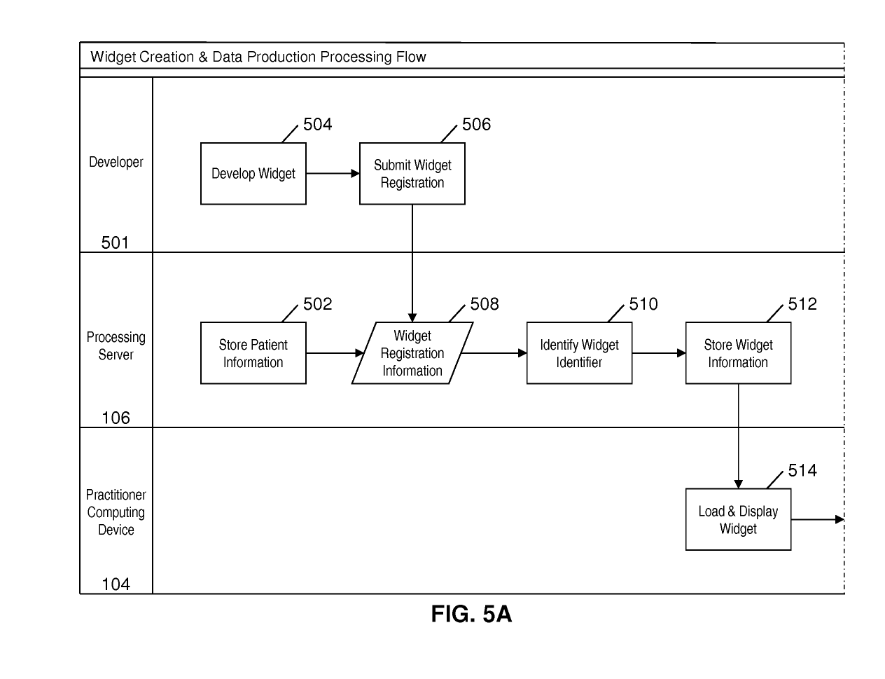

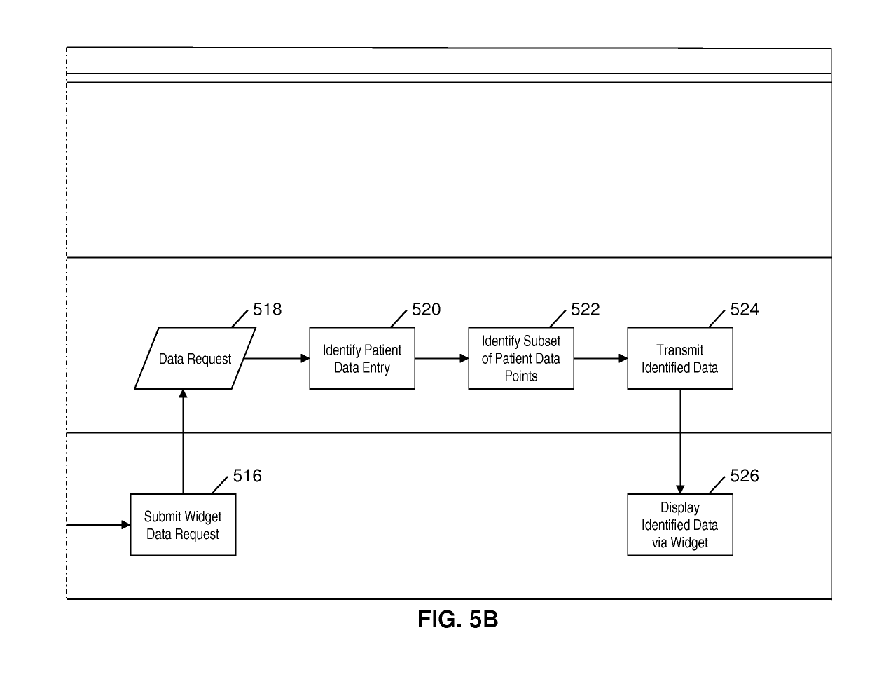

FIGS. 5A and 5B illustrate a method for the creation of a widget and the distribution of patient data via the created widget.

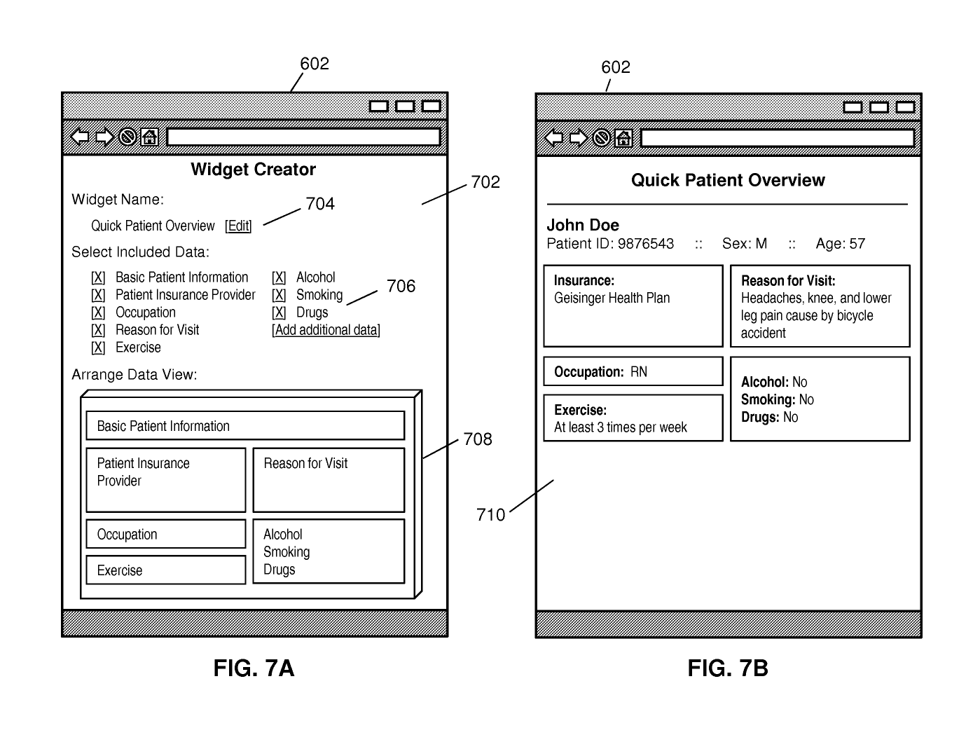

In step 502, the processing server 106 may store, in the patient database 206, patient information including patient data and patient identifiers for a plurality of patients 102. In step 504, a developer 501 may develop a widget to be used by health care professionals (e.g., the health care team member 110 and the provider 112) for accessing and/or modifying patient data. The developer 501 may be any person or entity capable of developing a widget, such as a programmer, a software developer, a health care provider 114, the provider 112, etc. In some instances, the processing server 106 may provide an interface for the design and/or creation of a widget, such as illustrated below with respect to FIGS. 7A and 7B.

In step 506, the developer 501 may submit widget registration information to the processing server 106, which may be received at step 508. The widget registration information may include at least an identification of a subset of patient data points. In some embodiments, the widget registration information may include a plurality of subsets of patient data points, each plurality being associated with one or more access controls. In other embodiments, the widget registration information may include one or more interface layouts, which may also be associated with one or more access controls and/or subsets of patient data points.

In step 510, the processing server 106 may identify a widget identifier to associate with the widget registration information. Methods for identifying an identifier to associate with the widget registration information will be apparent to persons having skill in the relevant art including selecting from a table of identifier, generation of a random identifier, generating an identifier based on the registration information, or any other suitable method. In step 512, the processing server 106 may store the widget registration information and widget identifier in the widget database 210 as a widget data entry.

In step 514, the practitioner computing device 104 (e.g., the computing device 104b and/or 104c) may access the widget (e.g., via the network 108) and may load the widget for display on the display unit 218. The user of the practitioner computing device 104 may then select a patient 102 to view data on using the widget, which may cause a widget data request to be submitted to the processing server 106 in step 516. The widget data request may include at least the widget identifier and a patient identifier for the selected patient 102.

In step 518, the processing server 106 may receive the widget data request identifying the widget and the patient 102, and then may, in step 520, identify a patient data entry in the patient database 206 corresponding to the patient identifier included in the widget data request. In step 522, the processing unit 204 may identify, in the identified patient data entry a subset of patient data points included in the patient data based on the subset of patient data points identified in the corresponding widget data entry in the widget database 210. In some embodiments, the widget data request may include a user identifier corresponding to the user of the practitioner computing device 104, and the identified subset of patient data points may be based on access control information corresponding to the user.

In step 524, the processing unit 204 may transmit the identified patient data points to the practitioner computing device 104. The practitioner computing device 104 may receive the identified patient data points, and then may display them to the user via the widget in step 526. In some embodiments, the widget may be configured such that the user may change, add to, or otherwise modify the patient data points via the widget (e.g., using the input unit 226). In such an embodiment, the method may further include the receipt of modified patient data points by the input unit 226, the transmitting of the modified data points to the processing server 106, and the updating of the patient data points in the corresponding patient data entry.

### Graphical User Interface

FIGS. 6A-6E and 7A and 7B illustrate graphical user interfaces of the computing device 104 for implementing the systems and methods as disclosed herein. It will be apparent to persons having skill in the relevant art that the graphical user interfaces depicted in FIGS. 6A-6D and 7A and 7B are provided as illustrations only, and that other interfaces may be suitable for performing the functions disclosed herein.

FIG. 6A illustrates an interface of a patient questionnaire presented to the patient 102, such as upon the patient 102 first visiting a health care provider. As illustrated in FIG. 6A, a web browsing application program 602 may be used to display a web page 604. Although the interface is illustrated as being displayed via a web page 604, it will be apparent to persons having skill in the relevant art that the interfaces disclosed herein may be displayed using a variety of methods and application programs.

The webpage 604 may include patient information 606. The patient information 605. The patient information 605 may include basic information related to the patient 102, such as name, patient identifier, gender, and age. The web page 604 may also include a pain key 606 accompanied by a pain survey 608. The pain survey 608 may be used by the patient 102 to indicate pain the patient 102 may be having specifying both the location and the intensity of the pain based on the pain key 606. For example, as illustrated in FIG. 6A, the patient 102 John Doe indicates mild head and lower left leg pain, and severe right knee pain.

The web page 604 may also include an allergy survey 610, which may include radio buttons used by the patient 102 to indicate if the patient is allergic to any medication or has no known medical allergies. If the patient 102 indicates that they are allergic to a medication, then the patient 102 may enter in the medication(s) in a medication field 612. In some embodiments, the web page 604 may not include the medication field 612. In such an embodiment, the patient 102 may answer only yes or no questions, or may only be presented with predefined answers to questions. Once the questionnaire answers are provided to the health care team member 110, the health care team member 110 may ask the patient 102 and fill in additional information (e.g., the medication field 612).

The web page 604 may also include a submit button 614 that, once interacted with by the patient 102, may cause the computing device 104a to submit the patient answers to the processing server 106. It will be apparent to persons having skill in the relevant art that the patient questionnaire illustrated in FIG. 6A may have different and/or additional questions, and may, in some instances, display more or less questions to the patient 102 depending on previous answers.

FIG. 6B illustrates a patient status screen 616, which may be displayed to the health care team member 110 via the computing device 104b. The patient status screen 616 may include user information 617, which may indicate the user that is currently accessing the patient status screen 616, such as Nurse Jill Smith as illustrated in FIG. 6B. The patient status screen 616 may also include a patient listing. The patient listing may include a list of current patients (e.g., at the health care provider, in a specific department, associated with the current user, etc.). The list of current patients may include, for each patient, a patient name 618, patient status 620, and room number 622 where the patient is located.

Once the patient has finished their questionnaire, the patient status 620 for the corresponding patient may be updated to indicate completion of the questionnaire. The patient status screen 616 may also display a notification 624, to notify the user that the associated patient has finished their questionnaire so that the user can more efficiently provide care to the patient.

FIG. 6C is an illustration of a patient information screen 626 displayed to a provider 112 via the computing device 104c. The patient information screen 626 may display patient data corresponding to the patient 102 indicated by patient information 605. In some embodiments, the patient information screen 626 may differ from other patient information screens based on user access controls. For example, the patient information screen 626 illustrated in FIG. 6C may be specially configured for physicians 112, while a patient information screen 638 illustrated in FIG. 6D may be specially configured for medical care providers 110.

The patient information screen 626 may include information that may be relevant for use by a provider 112 when seeing and/or treating a patient 102 as will be apparent to persons having skill in the relevant art. In one embodiment, as illustrated in FIG. 6C, the patient information screen 626 may include patient information 628 regarding what has happened to the patient 102 since their last visit, family history 630, and social history 632. The patient information screen 626 may also include a review of symptoms 634 (e.g., based on answers to the patient questionnaire) and patient comments 636.

As illustrated in FIG. 6D, the patient information screen 638 as accessed by the health care team member 110 may include the patient information 605 and different information from the patient information screen 626 as accessed by the provider 112. The patient information screen 638 may include insurance information 640; the information 628, family history 630, and social history 632 for the patient 102, a reason for visit 640 as provided by the patient 102, and a task list 642. The task list 642 may include tasks to be performed by the health care team member 110 or other health care professionals as part of the patient's 102 visit.

In embodiments where the patient questionnaire may include only predefined answers, the patient information screen 638 presented to the health care team member 110 may include a plurality of data entry fields for entering additional information. For example, the patient 102 may indicate on the questionnaire that there have been additional events that happened since their last visit. The health care team member 110 may then query the patient 102 when seeing the patient 102, and enter in the information 628 via a data entry field, e.g., after discovering that the patient 102 had been diagnosed with diabetes and suffered a fracture to their left wrist since their last visit. Such a system makes it easier and more efficient for the patient 102 to answer the questionnaire, and enables the health care team member 110 to gather a more accurate history that is also entered for presentation to the provider 112 in such a way as to be more easily understood, in conformity with conventions or protocols, accurate and complete, thereby increasing data integrity.

It will be apparent to persons having skill in the relevant art that the systems and methods disclosed herein may use additional interfaces to those illustrated in FIGS. 6A-6D. For example, an interface may be used to display trends, such as trends regarding patient information (e.g., changes in weight, height, etc.), pain, medical treatment, etc. In some instances, trends may be displayed using a color scheme, such as using red, yellow, and green colors (e.g., to indicate injury, treatment, and healthy status).

In another example, an interface may be used to display and/or print or distribute reports, such as an after visit summary. In some instances, multiple version of a report may be generated and/or printed, such as versions of a report for the patient 102, for including in the patient's 102 EMR, and for providing to an insurance provider of the patient 102. Such an after visit summary or other similar report may, in some instances, be provided in conjunction with another report or data as part of the aggregation and synchronization of data by the processing server 106. For example, a clinic note may include information that is automatically entered from various sources (e.g., the patient questionnaire, physician instructions, nursing notes, etc.), and may then be instructed to produce the after visit summary or other report based on the automatically entered information. In one embodiment, such an interface may be programmed such that the clinic note may contain information that is both relevant to and presented in terms suitable for health care providers, whereas a generated report may contain information that is more relevant and presented in terms more suitable for the patient 102.

In such an embodiment, each entity may receive the correct information, while ensuring that the information is both accurate and synchronized between the different reports. The clinic note and/or after visit summary may also be configured to enable auditing of patient care and the disclosure of information to the patient. By the processing server 106 aggregating data, it may be configured to track what reports are generated and distributed as well as the information included therein. In some instances, the processing server 106 may be configured to provide necessary information directly to the patient 102 (e.g., via e-mail, etc.) in order to comply with disclosure requirements and/or provide a more efficient system. For example, the processing server 106 may regularly provide trend diagrams, such as the diagram illustrated in FIG. 6E, to keep the patient 102 informed of their progress and of any additional actions needed to be performed as part of their care.

In yet another example, an interface may be used for the physician to provide notes regarding pain severity, tenderness of joints, swelling of joints, bone condition, etc. For instance, the pain survey 608 (e.g., shown in the form of a homunculus for visual presentation of a great deal of information in an easily understood format) may be modified or used by the provider 112 to record information regarding the condition of the patient 102. In a further example, multiple surveys may be taken over a period of time (e.g., over multiple visits) and trends may be developed based on the multiple surveys.

FIG. 6E illustrates an example trend diagram that may be viewable by the provider 112, health care team member 110, patient 102, etc. In some instances, the diagram may be beneficial for the provider 112 to review in the presence of the patient 102 to provide an easy to understand summary of the patient's condition, treatment, and their progress. The trend diagram 648 may be display as a web page on a web browser 102, or as part of an application program. The trend diagram may include the patient information 605 to indicate the patient whose trends are being reviewed.

The trend diagram may also include a timeline 644. The timeline 644 may display a range of dates over which the trend is being viewed. It will be apparent to persons having skill in the relevant art that the timeline 644 may be modified or adjusted by the user of the computing device 104, and, in some instances, may vary based on the trends being viewed, such as showing a shorter timeline 644 for faster healing conditions and a longer timeline 644 for chronic illnesses, or permit scrolling through a larger trend line.

The trend diagram may also include a trend legend 646 in conjunction with a trend chart 648. The trend legend 646 may include multiple trends to be displayed to the user as well as icons or other representations of the respective trends on the trend chart 648. The trend chart 648 may display levels or values for each of the respective trends being displayed over time in conjunction with the trend timeline. As illustrated in FIG. 6E, in some embodiments, multiple trend charts 648 may be displayed in order to accommodate a larger number of trends.

Additionally, the data points can be shown via a series of homunculi, such as shown in FIGS. 6A and 6C, to graphically show the spread or retraction of an ailment, e.g., arthritis in the illustrated joints of the exemplary homunculus. Of course, other ailments can be shown by selectively illustrating organs, muscles, nerve and/or circulatory systems, areas of the body, etc., complete with color coding, selective display, selective emphasis (e.g., highlighting particular body parts or trends), hyperlinks to data values or other information about the illness or ailment.

The trend diagram may also include a medication listing 650, which may be accompanied by a medication indicator 652. The medication indicator 652 may use some form of display to indicate when the patient 102 was being treated by the respective medication as indicated in the medication listing 650, such as by displayed shaded boxes as illustrated in FIG. 6E. The use of the medication indicator 652 in conjunction with the trend chart 648 may enable the provider 112 and patient 102 to see the effects of medication on the treatment of the patient's condition. For example, FIG. 6E illustrates that the patient experienced decreased joint tenderness when using Prednisone, and then more drastically once also prescribed MTX Oral, as well as significantly decreased fatigue upon the prescribing of Prednisone.

FIGS. 7A and 7B illustrate a graphical user interface of the computing device 104 for the creation of widgets and the distribution of patient information thereby.

As illustrated in FIG. 7A, a web browsing application 602 or other application program may display a widget creator 702. The widget creator 702 may include a widget name 704, which may be edited by the user (e.g., the developer 501). The widget creator 702 may also include a plurality of patient data points 706, which may include a subset of the patient data points included in the patient data of a patient data entry stored in the patient database 206. In some embodiments, multiple selections of patient data points may be used and associated with access control information (e.g., for multiple user categories).

The widget creator 702 may also include a widget layout 708. The widget layout 708 may be a representation of the display of the patient data points selected in the plurality of patient data points 706. In some instances, the user may be able to adjust the widget layout 708 using a drag-and-drop style interface or other suitable method that will be apparent to persons having skill in the relevant art.

As illustrated in FIG. 7B, once the widget is accessed by a user (e.g., the health care team member 110), the application 602 may display a widget screen 710. The widget screen 710 may include all of the data points identified by the widget (e.g., as stored in a corresponding widget data entry in the widget database 210) and may be formatted to be displayed according to the widget layout 708. In some instances, the patient data points displayed on the widget screen 710 may be configured to be editable by the user. In a further instance, the creator of the widget may identify specific patient data points that may be editable by a user of the widget.

### First Exemplary Method for Distributing Patient Data

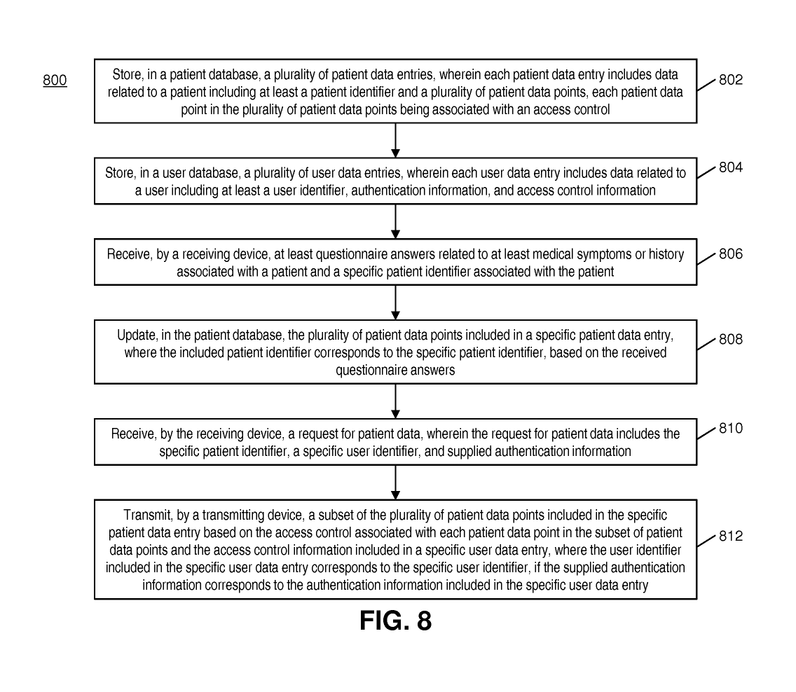

FIG. 8 illustrates a method 800 for the distribution of patient data by the processing server 106 to a computing device 104 for display to a health care professional.

In step 802, a plurality of patient data entries may be stored in a patient database (e.g., the patient database 206), wherein each patient data entry includes data related to a patient including at least a patient identifier and a plurality of patient data points, each patient data point in the plurality of patient data points being associated with an access control. In one embodiment, each data point in the plurality of data points includes data related to at least one of: medical treatment, symptoms, history, care, preferences, allergies, progress, observations, and health care outcomes. In some embodiments, the plurality of data points may include data supplied by at least one of: the patient 102 related to the corresponding patient data entry, a nurse (e.g., the health care team member 110), a physician (e.g., the provider 112), and an electronic medical record.

In step 804, a plurality of user data entries may be stored in a user database (e.g., the user database 208), wherein each user data entry includes data related to a user including at least a user identifier, authentication information, and access control information. In one embodiment, the access control information in each user data entry may correspond to at least one of: patient, nurse, physician, and health care provider.

In step 806, a receiving device (e.g., the receiving unit 202) may receive at least questionnaire answers related to at least medical symptoms or history associated with a patient (e.g., the patient 102) and a specific patient identifier associated with the patient 102. In some embodiments, the answers may be supplied by the patient themselves.

In step 808, the plurality of patient data points included in a specific patient data entry may be updated, in the patient database 206, based on the received questionnaire answers where the included patient identifier in the specific patient data entry corresponds to the specific patient identifier. In step 810, a request for patient data may be received, by the receiving device 202, wherein the request for patient data includes the specific patient identifier, a specific user identifier, and supplied authentication information. In one embodiment, the questionnaire answers may be received from a first input device (e.g., the computing device 104a) operated by the patient 102 related to the specific patient data entry and the request for patient data may be received from a second input device (e.g., the computing device 104b) operated by the user (e.g., the health care team member 110) related to the specific user data entry.

In step 812, a transmitting device (e.g., the transmitting unit 214) may transmit a subset of the plurality of patient data points included in the specific patient data entry based on the access control associated with each patient data point in the subset of patient data points and the access control information included in a specific user data entry, where the user identifier included in the specific user data entry corresponds to the specific user identifier, if the supplied authentication information corresponds to the authentication information included in the specific user data entry. In one embodiment, the plurality of patient data points may be transmitted for display on a display device (e.g., the display unit 218) configured to display an indication of trends related to medical symptoms or history of the patient related to the specific patient data entry. In a further embodiment, the indication may be displayed in at least one of a red, yellow, or green color.

### Second Exemplary Method for Distributing Patient Data

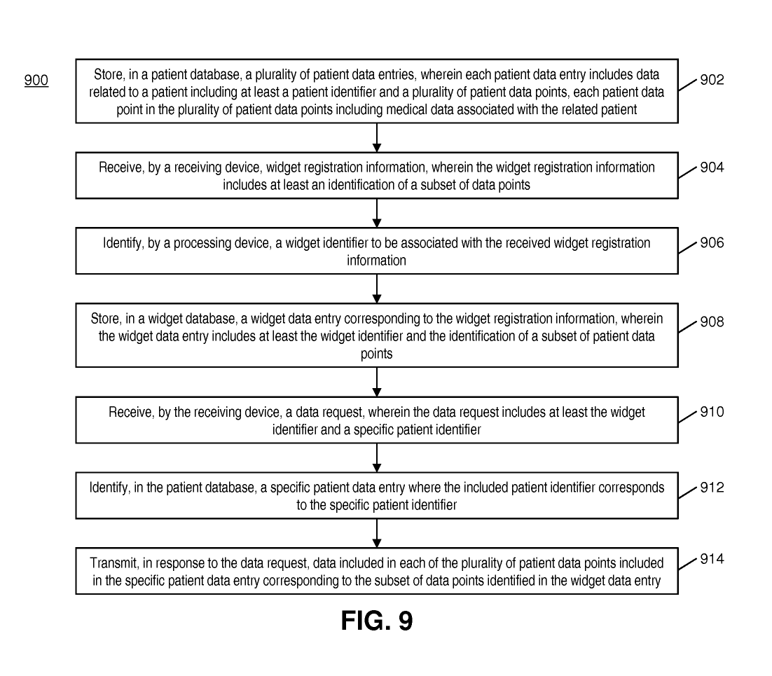

FIG. 9 illustrates a method 900 for the distribution of patient data via a widget by the processing server 106 to a computing device 104 for display to a health care professional.

In step 902, a plurality of patient data entries may be stored, in a patient database (e.g., the patient database 206), wherein each patient data entry includes data related to a patient (e.g., the patient 102) including at least a patient identifier and a plurality of patient data points, each patient data point in the plurality of patient data points including medical data associated with the related patient 102. In one embodiment, the medical data includes at least one of: medical treatment, symptoms, history, care, preferences, allergies, progress, observations, and health care outcomes. In some embodiments, the plurality of data points may include data supplied by at least one of: the patient 102 related to the corresponding patient data entry, a nurse (e.g., the health care team member 110), a physician (e.g., the provider 112), and an electronic medical record.

In step 904, a receiving device (e.g., the receiving unit 202) may receive widget registration information, wherein the widget registration information includes at least an identification of a subset of data points. In step 906, a processing device (e.g., the processing unit 204) may identify a widget identifier to be associated with the received widget registration information.

In step 908, a widget data entry may be stored, in a widget database (e.g., the widget database 210), corresponding to the widget registration information, wherein the widget data entry includes at least the widget identifier and the identification of a subset of patient data points. In step 910, the receiving device 202 may be configured to receive a data request, wherein the data request includes at least the widget identifier and a specific patient identifier.

In step 912, a specific patient data entry may be identified, in the patient database 206, where the included patient identifier corresponds to the specific patient identifier. In step 914, data included in each of the plurality of patient data points included in the specific patient data entry corresponding to the subset of data points identified in the widget data entry may be transmitted, in response to the data request.

In one embodiment, the method 900 may further include storing, in a user database (e.g., the user database e208), a plurality of user data entries, wherein each user data entry includes data related to a user including at least a user identifier, authentication information, and access control information, wherein: the data request further includes a specific user identifier and supplied authentication information; the data included in each of the plurality of data points included in the specific patient data entry is further based on the access control information included in a specific user data entry where the included user identifier corresponds to the specific user identifier; and the transmitting step is not performed if the supplied authentication information does not correspond to the authentication information included in the specific user data entry. In an even further embodiment, the access control information in each user data entry may correspond to at least one of: patient, nurse, physician, and health care provider.

### Exemplary Method for Notifying a Health Service Professional of Patient Status

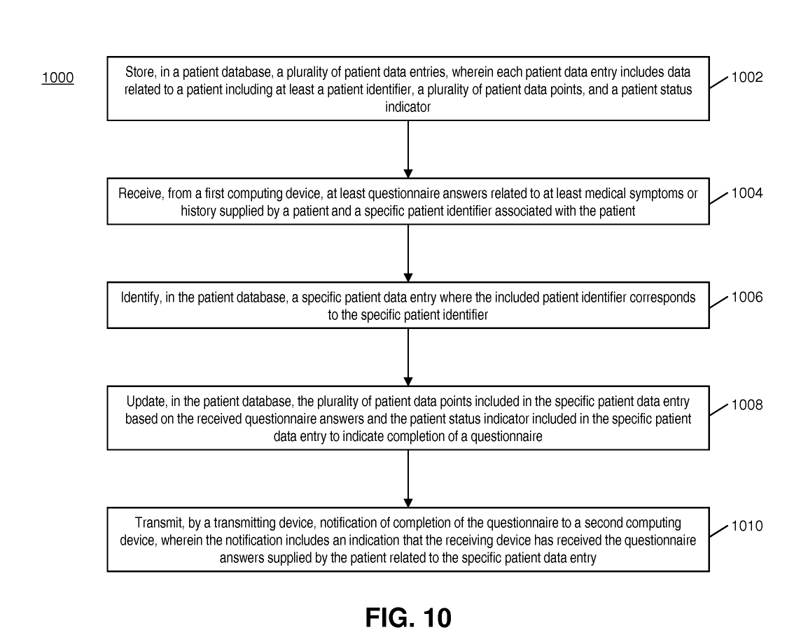

FIG. 10 illustrates a method 1000 for the notification of patient status to a health service professional via the computing device 104.

In step 1002, a plurality of patient data entries may be stored, in a patient database (e.g., the patient database 206), wherein each patient data entry includes data related to a patient (e.g., the patient 102) including at least a patient identifier, a plurality of patient data points, and a patient status indicator. In some embodiments, the plurality of patient data points included in each patient data entry may include medical data including at least one of: medical treatment, symptoms, history, care, preferences, allergies, progress, observations, and health care outcomes. In one embodiment, the plurality of patient data points may include data supplied by at least one of: a nurse (e.g., the health care team member 110), a physician (e.g., the provider 112), and an electronic medical record.

In step 1004, a receiving device (e.g., the receiving unit 202) may receive, from a first computing device (e.g., the computing device 104a), at least questionnaire answers related to at least medical symptoms or history supplied by a patient 102 and a specific patient identifier associated with the patient 102. In step 1006, a specific patient data entry may be identified in the patient database 206 where the included patient identifier corresponds to the specific patient identifier.

In step 1008, the plurality of patient data points included in the specific patient data entry in the patient database 206 may be updated based on the received questionnaire answers and the patient status indicator included in the specific patient data entry to indicate completion of a questionnaire. In step 1010, notification of completion of the questionnaire may be transmitted, by a transmitting device (e.g., the transmitting unit 214) to a second computing device (e.g., the computing device 104b), wherein the notification includes an indication that the receiving device 202 has received the questionnaire answers supplied by the patient 102 related to the specific patient data entry. In one embodiment, the second computing device 104b may be operated by an authenticated user and the notification may be transmitted to the second computing device 104b only if the authenticated user is authorized to view data related to the patient 102 related to the specific patient data entry.

Techniques consistent with the present disclosure provide, among other features, systems and methods for distributing patient data and notifications of patient status information. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

1. A method for distributing patient data, comprising:
storing, in a patient database, a plurality of patient data entries, wherein each patient data entry includes data related to a patient including at least a patient identifier and a plurality of patient data points, each patient data point in the plurality of patient data points being associated with an access control;
storing, in a user database, a plurality of user data entries, wherein each user data entry includes data related to a user including at least a user identifier, authentication information, and access control information;
receiving, by a receiving device, at least questionnaire answers related to at least medical symptoms or history associated with a patient and a specific patient identifier associated with the patient;
updating, in the patient database, the plurality of patient data points included in a specific patient data entry, where the included patient identifier corresponds to the specific patient identifier, based on the received questionnaire answers;
receiving, by the receiving device, a request for patient data, wherein the request for patient data includes the specific patient identifier, a specific user identifier, and supplied authentication information; and
transmitting, by a transmitting device, a subset of the plurality of patient data points included in the specific patient data entry based on the access control associated with each patient data point in the subset of the patient data points and the access control information included in a specific user data entry, where the user identifier included in the specific user data entry corresponds to the specific user identifier, if the supplied authentication information corresponds to the authentication information included in the specific user data entry.

2. The method of claim 1, wherein the subset of the plurality of patient data points is transmitted for display on a display device configured to display an indication of trends related to medical symptoms or other history of the patient related to the specific patient data entry.

3. The method of claim 2, wherein the indication is displayed in at least one of: a red, yellow, or green color.

4. The method of claim 1, wherein the questionnaire answers are received from a first input device operated by the patient related to the specific patient data entry and the request for patient data is received from a second input device operated by the user related to the specific user data entry.

5. The method of claim 1, wherein the access control information in each user data entry corresponds to at least one of: patient, nurse, physician, and other health care provider.

6. The method of claim 1, wherein each data point in the plurality of data points includes data related to at least one of: medical treatment, symptoms, history, care, preferences, allergies, progress, observations, and health care outcomes.

7. The method of claim 1, wherein the plurality of data points includes data supplied by at least one of: the patient related to the corresponding patient data entry, a health care provider, a physician, and an electronic medical record.

8. A method for distributing patient data, comprising:
storing, in a patient database, a plurality of patient data entries, wherein each patient data entry includes data related to a patient including at least a patient identifier and a plurality of patient data points, each patient data point in the plurality of patient data points including medical data associated with the related patient;
receiving, by a receiving device, widget registration information, wherein the widget registration information includes at least an identification of a subset of patient data points;
identifying, by a processing device, a widget identifier to be associated with the received widget registration information;
storing, in a widget database, a widget data entry corresponding to the widget registration information, wherein the widget data entry includes at least the widget identifier and the identification of the subset of patient data points;
receiving, by the receiving device, a data request, wherein the data request includes at least the widget identifier and a specific patient identifier;
identifying, in the patient database, a specific patient data entry where the included patient identifier corresponds to the specific patient identifier; and
transmitting, in response to the data request, data included in each of the plurality of patient data points included in the specific patient data entry corresponding to the subset of data points identified in the widget data entry.

9. The method of claim 8, further comprising:
storing, in a user database, a plurality of user data entries, wherein each user data entry includes data related to a user including at least a user identifier, authentication information, and access control information, wherein
the data request further includes a specific user identifier and supplied authentication information,
the data included in each of the plurality of data points included in the specific patient data entry is further based on the access control information included in a specific user data entry where the included user identifier corresponds to the specific user identifier, and
the transmitting step is not performed if the supplied authentication information does not correspond to the authentication information included in the specific user data entry.

10. The method of claim 9, wherein the access control information in each user data entry corresponds to at least one of: patient, nurse, physician, and other health care provider.

11. The method of claim 8, wherein the medical data includes at least one of medical treatment, symptoms, history, care, preferences, allergies, progress, observations, and health care outcomes.

12. The method of claim 8, wherein the plurality of data points includes data supplied by at least one of: the patient related to the corresponding patient data entry, a health care provider, a physician, and an electronic medical record.

13. A method for notifying a health service professional of patient status, comprising:
storing, in a patient database, a plurality of patient data entries, wherein each patient data entry includes data related to a patient including at least a patient identifier, a plurality of patient data points, and a patient status indicator;
receiving, from a first computing device, at least questionnaire answers related to at least medical symptoms or history supplied by a patient and a specific patient identifier associated with the patient;
identifying, in the patient database, a specific patient data entry where the included patient identifier corresponds to the specific patient identifier;
updating, in the patient database, the plurality of patient data points included in the specific patient data entry based on the received questionnaire answers and the patient status indicator included in the specific patient data entry to indicate completion of a questionnaire; and
transmitting, by a transmitting device, notification of completion of the questionnaire to a second computing device, wherein the notification includes an indication that the receiving device has received the questionnaire answers supplied by the patient related to the specific patient data entry.

14. The method of claim 13, wherein the second computing device is operated by an authenticated user and the notification is transmitted to the second computing device only if the authenticated user is authorized to view data related to the patient related to the specific patient data entry.

15. The method of claim 13, wherein the plurality of patient data points included in each patient data entry includes medical data including at least one of: medical treatment, symptoms, history, care, preferences, allergies, progress, observations, and health care outcomes.

16. The method of claim 13, wherein the plurality of data points includes data supplied by at least one of: the patient related to the corresponding patient data entry, a health care provider, a physician, and an electronic medical record.

17. A system for distributing patient data, comprising:
a transmitting device;
a patient database configured to store a plurality of patient data entries, wherein each patient data entry includes data related to a patient including at least a patient identifier and a plurality of patient data points, each patient data point in the plurality of patient data points being associated with an access control;
a user database configured to store a plurality of user data entries, wherein each user data entry includes data related to a user including at least a user identifier, authentication information, and access control information;
a receiving device configured to receive at least questionnaire answers related to at least medical symptoms or history associated with a patient and a specific patient identifier associated with the patient; and
a processing device configured to update, in the patient database, the plurality of patient data points included in a specific patient data entry, where the included patient identifier corresponds to the specific patient identifier, based on the received questionnaire answers, wherein
the receiving device is further configured to receive a request for patient data, wherein the request for patient data includes the specific patient identifier, a specific user identifier, and supplied authentication information, and
the transmitting device is configured to transmit a subset of the plurality of patient data points included in the specific patient data entry based on the access control associated with each patient data point in the subset of the patient data points and the access control information included in a specific user data entry, where the user identifier included in the specific user data entry corresponds to the specific user identifier, if the supplied authentication information corresponds to the authentication information included in the specific user data entry.

18. The system of claim 17, wherein the transmitting device is configured to transmit the subset of the plurality of patient data points for display on a display device configured to display an indication of trends related to medical symptoms or history of the patient related to the specific patient data entry.

19. The system of claim 18, wherein the indication is displayed in at least one of: a red, yellow, or green color.

20. The system of claim 17, wherein the questionnaire answers are received from a first input device operated by the patient related to the specific patient data entry and the request for patient data is received from a second input device operated by the user related to the specific user data entry.

21. The system of claim 17, wherein the access control information in each user data entry corresponds to at least one of: patient, nurse, physician, and other health care provider.

22. The system of claim 17, wherein each data point in the plurality of data points includes data related to at least one of: medical treatment, symptoms, history, care, preferences, allergies, progress, observations, and health care outcomes.

23. The system of claim 17, wherein the plurality of data points includes data supplied by at least one of: the patient related to the corresponding patient data entry, a health care provider, a physician, and an electronic medical record.

24-32. (canceled)
